(19) United States
(12) Patent Application Publication
(10) Pub. No.: US 2023/0182513 A1
(43) Pub. Date: Jun. 15, 2023

(54) INTERNAL FIXATION OF A TYRE PRESSURE SENSOR ON THE RIM

(71) Applicant: WHEELY-SAFE LTD., Staffordshire (GB)

(72) Inventor: Gary Broadfield, Staffordshire (GB)

(21) Appl. No.: 17/922,242

(22) PCT Filed: Apr. 27, 2021
(86) PCT No.: PCT/EP2021/061010

§ 371 Date: Oct. 28, 2022

(30) Foreign Application Priority Data
Apr. 29, 2020 (GB) 2006295.6

(51) Int. Cl. B60C 23/04

(52) U.S. Cl. CPC B60C 23/0498; B60C 23/0433; B60C 23/0486

(57) ABSTRACT

A tyre pressure sensing module for fitting to a rim of a wheel of a vehicle, the rim configured to accommodate a tyre. The tyre pressure sensing module comprises a pressure sensor apparatus configured to sense a pressure of a fluid retained within the tyre, and a sensor mount. The sensor mount is for securing the pressure sensor apparatus to the rim of the wheel. The sensor mount comprises a mounting area configured to be adhered to the rim and that is deformable to accommodate a radius of the rim.

### TECHNICAL FIELD

The invention relates to tyre pressure sensing modules. In particular, the invention may relate to internal tyre pressure sensing modules for fitting to a rim of a wheel.

### BACKGROUND

Tyre pressure monitoring systems, TPMSs, typically comprise pressure sensing modules configured to provide data relating to the pressure of a fluid, typically air, contained within a pneumatic tyre of a vehicle. TPMS may comprise external or internal pressure sensing modules. External pressure sensing modules may be configured for fitting to a valve stem of a wheel. In contrast, internal pressure sensing modules may be configured for fitting internally, within the volume of the tyre and typically to a rim of the wheel. In such arrangements, the pressure sensing module may be located in the volume formed between the rim of the wheel and an inner surface of the tyre.

External pressure sensing modules can be easily fitted to the valve stem, for example, using screw thread arrangements. In contrast, fitting the internal pressure sensing modules to the wheel rim is typically trickier and more time intensive. For example, known internal pressure sensing modules may be mounted to the rim of the wheel using screws or using a metal band secured around the rim.

Further, internal pressure sensors are typically only suitable for mounting to a single size of wheel. That is, the internal pressure sensor is specifically designed to fit a single wheel rim radius. As such, the internal pressure sensor needs to be manufactured in different sizes to accommodate different wheel rim radii, and a user is required to ensure that they have the correct size for each wheel.

It is therefore desirable to provide an internal tyre pressure sensing module that may accommodate different sized wheels and which is simple to fit.

### SUMMARY

According to the invention in a first aspect, there is provided a tyre pressure sensing module for fitting to a rim of a wheel of a vehicle, the rim configured to accommodate a tyre, the tyre pressure sensing module comprising: a pressure sensor apparatus configured to sense a pressure of a fluid retained within the tyre; and a sensor mount for securing the pressure sensor apparatus to the rim of the wheel, wherein the sensor mount comprises a mounting area configured to be adhered to the rim and that is deformable to accommodate a radius of the rim.

Optionally, the mounting area is deformable to accommodate radii of a plurality of rims.

Optionally, the mounting area is flexibly deformable to accommodate the radius of the rim or the radii of the plurality of rims.

Optionally, the sensor mount comprises a mounting flange, and wherein the mounting area comprises at least part of an underside of the mounting flange.

Optionally, the mounting flange extends laterally in at least one direction beyond a periphery of the pressure sensor apparatus.

Optionally, the tyre pressure sensing module further comprises a housing configured to at least partially enclose the pressure sensor apparatus.

Optionally, the sensor mount comprises the housing.

Optionally, the housing comprises a recess formed in the mounting flange, and the pressure sensor apparatus is received within the recess.

Optionally, the tyre pressure sensing module further comprises a cover covering an opening of the recess in the mounting flange.

Optionally, the mounting area comprises at least part of the mounting flange and at least part of the cover.

Optionally, the housing comprises an aperture allowing fluid communication from an internal volume of the tyre to the pressure sensor apparatus.

Optionally, the mounting flange and the housing are formed in a continuous piece.

Optionally, the sensor mount comprises a deformable sheet. The deformable sheet may comprise one of: and elastically deformable sheet, a plastically deformable sheet, and a flexibly deformable sheet.

Optionally, at least part of the mounting flange is formed by the deformable sheet.

Optionally, at least part of the housing is formed by the deformable sheet.

Optionally, the tyre pressure sensing module further comprises an adhesive located on at least a portion of the mounting area.

Optionally, the adhesive comprises a double sided tape, a first side of the double sided tape being adhered to the mounting area, and a second side of the double sided tape configured for adherence to the rim.

Optionally, the housing comprises at least one angled sidewall.

Optionally, the housing comprises a pair of opposed angled sidewalls.

Optionally, the tyre pressure sensing module further comprises a plurality of pressure sensors configured to sense the pressure of a fluid retained within the tyre.

Optionally, the tyre pressure sensing module further comprises a transmitter configured to transmit data indicative of the sensed pressure of the fluid.

Optionally, the tyre pressure sensing module further comprises a temperature sensor configured to sense the temperature of the fluid retained within the tyre.

Optionally, at least a portion of the mounting area comprises a thermoplastic material.

According to the invention in a further aspect, there is provided a wheel of a vehicle comprising: a rim configured to accommodate a tyre; and a tyre pressure sensing module according to any of claims 1 to 23 adhered to the rim.

Optionally, the wheel may further comprise the tyre.

According to the invention in a further aspect, there is provided a vehicle comprising a wheel according to claim 24.

According to the invention in a further aspect, there is provided a dispensing apparatus configured to store and dispense a plurality of tyre pressure sensing modules, the dispensing apparatus comprising: a plurality of tyre pressure sensing modules according to claim 17 or any of claims 18 to 23 when dependent directly or indirectly on claim 17; a reel; and a length of dispensing material wound about the reel, wherein the second side of the double sided tape of each of the plurality of tyre pressure sensing modules is adhered to the length of dispensing material, and wherein removal of any one of the plurality of tyre pressure sensing modules from the length of dispensing material exposes the second side of the double sided tape for installation of the tyre pressure sensing module on the wheel rim.

### BRIEF DESCRIPTION OF THE DRAWINGS

FIG. 1a is a perspective view of an exemplary tyre pressure sensing module;

FIG. 1b is a section view of an exemplary tyre pressure sensing module;

FIG. 1c is a perspective view of an exemplary tyre pressure sensing module fitted to a wheel rim;

FIG. 2 is a perspective view of an exemplary tyre pressure sensing module;

FIG. 3a is a perspective view of an exemplary tyre pressure sensing module;

FIG. 3b is a side view of the exemplary tyre pressure sensing module of FIG. 3a; and

FIG. 4 shows a dispensing apparatus.

### DETAILED DESCRIPTION

Generally disclosed herein is a tyre pressure sensing module suitable for fitting to rims of wheels with different radii. In exemplary arrangements, the tyre pressure sensing module comprises a pressure sensor apparatus and a sensor mount comprising a mounting area that is deformable to conform to a radius of a wheel rim. The mounting area may be deformable to different extents depending on the radius of the rim of the wheel to which the tyre pressure sensing module is to be fitted. In exemplary arrangements, the mounting area may be secured to the rim using an adhesive. In exemplary arrangements, the tyre pressure sensing module may comprise the adhesive. As such, to fit the tyre pressure sensing module to the rim of the wheel, the user simply needs to place the tyre pressure sensing module on to the rim and deform the mounting area to conform to the radius of the rim. The user may then apply pressure to the tyre pressure sensing module to adhere the tyre pressure sensing module to the rim.

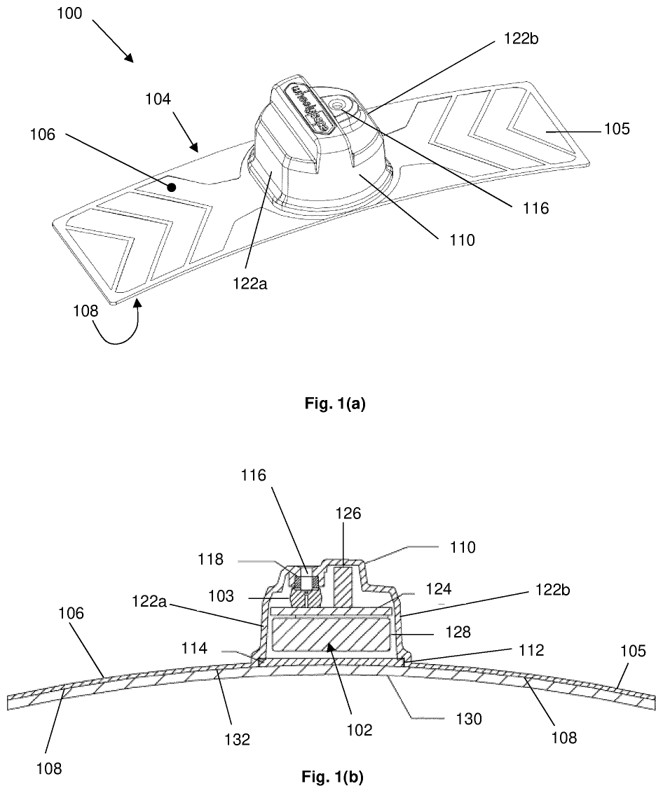

FIG. 1a shows an exemplary tyre pressure sensing module 100 and FIG. 1b shows a cross-sectional view of the exemplary tyre pressure sensing module 100.

The tyre pressure sensing module 100 may be an internal tyre pressure sensing module. As described above, internal tyre pressure sensing modules may be configured for fitting to a rim of a wheel, the rim configured to accommodate a tyre. As such, the tyre pressure sensing module 100 may be for fitting to a rim such that the tyre pressure sensing module is located in a volume formed between the wheel rim and an inner surface of the tyre. In specific arrangements, the tyre pressure sensing module 100 is configured to be secured to a radially outer surface of the rim, which forms part of the inner volume of the tyre.

The tyre pressure sensing module 100 comprises a pressure sensor apparatus 102 and a sensor mount 104. As used herein, the term “pressure sensor apparatus” may encompass a plurality of features necessary for operation of a pressure sensor 103, for example a battery and/or a transmitter and/or a receiver.

In the exemplary arrangement of FIG. 1a, the pressure sensor apparatus 102 is configured to sense the pressure of a fluid retained within a tyre of a vehicle. At least a portion of the pressure sensor 103 is exposed to the fluid within the tyre when fitted and in use.

The sensor mount 104 may be configured for securing the pressure sensor to the rim of the wheel. The exemplary sensor mount 104 may comprise a mounting flange 105 having an upper surface 106 and a lower surface at least partly forming a mounting area 108 configured to be adhered to the rim of the wheel. The exemplary sensor mount 104 may further comprise a housing 110 configured to receive the pressure sensor 102.

At least part of the mounting area 108 of the sensor mount 104 is deformable to accommodate a radius of the rim of the wheel to which the pressure sensor 102 is to be secured. That is, the mounting area 108 is deformable to conform to the rim of the wheel. In the exemplary arrangement of FIG. 1a, the mounting flange 105 is deformable. Therefore, the mounting area 108 that is at least partly formed by an underside of the mounting flange 105 is also deformable.

As used throughout this specification, the term “deformable” or “deform” encompasses bending or deflecting the mounting area to change the profile of the mounting area. In particular, the mounting area may be deformed, or bent or deflected, such that a profile of the mounting area conforms to a profile of the wheel rim to which the tyre pressure sensing module is to be fitted to. FIG. 1b, for example, shows that the profile of the mounting area 108 has been deformed into a curved shape, which may correspond to the radius of a wheel rim. The deformation (or bending or deflecting) of the mounting area may occur under force applied by the user, or alternatively under gravitational force. Deformation may encompass one or more of flexible deformation, elastic deformation and plastic deformation.

In the exemplary arrangement of FIG. 1, the mounting area 108 may be deformable to accommodate different sized wheel rims. The mounting area 108 may be deformable to different extents such that a single tyre pressure sensing module 100 may be fitted to a plurality of wheels with rims of different radii. In exemplary arrangements, the mounting area 108 may be deformable to accommodate radii of wheel rims of 50 mm and greater; 100 mm and greater; and 150 mm and greater. The mounting area 108 may therefore be deformable to accommodate the radii of, for example, cars which may typically have a rim radius of 150 mm or greater; HGVs which may typically have a rim diameter of 250 mm or greater; motorbikes which may typically have a rim diameter of 200 mm or greater. The skilled person will appreciate that these are examples only, and the mounting area 108 may be deformable to accommodate further sized wheels.

The mounting area 108 may be curved. That is, the mounting area 108 may be curved in a non-deformed state, before a force is applied to the mounting area 108 to deform the mounting area 108. In such arrangements, the curve of the mounting area 108 may form an arc of a circle. The mounting area 108 may comprise an arc of a circle having a radius of one of: 200 mm or greater; 250 mm or greater; and 300 mm or greater. The mounting area 108 may be deformed such that the radius of the circle formed by the arc of the curved mounting area 108 in the non-deformed state is increased or decreased so that the mounting area 108 conforms to wheel rims of greater or smaller radii.

The mounting area 108 may be elastically, plastically or flexibly deformable to conform to the radius of the wheel rim. In exemplary arrangement shown in FIGS. 1a and 1b, the mounting area is elastically or plastically deformable. Elastic deformation encompasses deformation of the mounting area 108 without permanent distortion of the mounting area. In such arrangements, the mounting area 108 may return to its original shape when an applied deformation force is removed. For example, in arrangements in which the mounting area 108 is curved, the mounting area 108 may return to its original curved shape when the force is removed. Plastic deformation encompasses permanent distortion of the shape of the mounting area as a result of a deformation to accommodate a rim of a wheel. In such arrangements, the mounting area 108 does not return to its original shape once the applied force is removed. The skilled person will appreciate an elastically deformable material will eventually deform plastically if the extent of deformation is too great. For the purpose of this specification, elastic deformation encompasses elastic deformation to accommodate a plurality of wheel rims of different radii, and plastic deformation encompasses plastic deformation to accommodate a plurality of wheel rims of different radii. Flexible deformation encompasses deformation of the mounting area 108 under gravitational force. As such, a flexibly deformable mounting area 108 may conform to the shape of whatever surface it is placed on without requiring an applied force.

In exemplary arrangements, the mounting area 108 is a surface of the mounting flange 105 and in such arrangements, the mounting flange 105 may be elastically or plastically deformable. In the exemplary tyre pressure sensing module 100, the mounting flange 105 may comprise a deformable sheet. The sheet may be elastically deformable or plastically deformable (or in further arrangements, the deformable sheet may comprise a flexible sheet). Exemplary mounting flanges 105 may be substantially rectangular. However, the skilled person will appreciate that the mounting flange 105 may be of substantially any shape. In exemplary arrangements, at least part of the housing may be formed by the deformable sheet. In the arrangement shown in FIGS. 1a and 1b, the housing 110 and the mounting flange are formed by the deformable sheet, however the skilled person will appreciate that in alternative arrangements, a portion of the housing 110 and/or the mounting area 105 may be formed by the deformable sheet. In exemplary arrangements, the mounting flange 105 (and in some arrangements, also the sensor mount 104) may be elastically or plastically deformable under an applied force. The applied force may be of the order applicable by a human user. In further exemplary arrangements the mounting flange 105 (and in some arrangements, also the sensor mount 104) may be flexibly deformable under the force of gravity.

The skilled person will appreciate that the term “flexible” or “deformable” encompasses components/objects with a low stiffness. As used throughout this specification, the term “stiffness” encompasses the extent to which an object or component resists deformation under an applied force. As such, the unit displacement of a flexible or deformable material under a given force is greater than the unit displacement of a stiffer material under the same force. Flexible/deformable materials may be considered as those materials with a stiffness that allows the mounting area 108 to be deformed to conform to radii of 100 mm or greater under an applied force of the order applicable by a human. The order of force applicable by a human may be one of 2 N or less; 5 N or less; 10 N or less; 15 N or less; or 20 N or less. In exemplary arrangements, flexible materials may be considers those materials with a stiffness that allows the mounting area 108 to be deformed from a non-deformed radius of 250 mm to conform to radii of 100 mm or greater under an applied force of the order applicable by a human, which may be one of 2 N or less; 5 N or less; 10 N or less; 15 N or less; or 20 N or less.

The skilled person will appreciate that the stiffness of the mounting flange 105 (and in some arrangements, also the sensor mount 104) may be dependent on the material of the mounting flange 105 and/or its geometry, in particular the thickness of the mounting flange 105. Therefore, the stiffness of the material of the mounting flange 105 (and in some arrangements, also the sensor mount 104) to achieve the exemplary ranges mentioned herein may be based on a combination of material properties and geometry, in particular thickness.

Exemplary mounting flanges 105 may comprise a plastics material, for example, a thermoplastic. Advantageously, using thermoplastics allows the mounting flange 105 to be manufactured using injection moulding. In exemplary arrangements, the mounting flange 105 may comprise an engineering grade thermoplastic, for example a polyamide. In one example, the mounting flange 105 may comprise PA66, and optionally glass-filled PA66. In one example, the mounting flange 105 may comprise PA66, 30% glass-filled. The skilled person will appreciate that in alternative arrangements, the mounting flange 105 may comprise alternative materials, such as metals or alternative plastics, carbon fibres or meshes.

In the exemplary arrangement of FIGS. 1a and 1b, the thickness of the mounting flange 105 may be one of: 2 mm or less; 1 mm or less, 0.7 mm or less, and 0.5 mm or less. The skilled person will appreciate that alternative dimensions may be used in alternative arrangements, and that these dimensions may depend on the material of the mounting flange 105.

The mounting flange 105 extends laterally in at least one direction beyond a periphery of the pressure sensor apparatus 102. That is, the mounting flange 105 has a lateral cross sectional area greater than that of the pressure sensor apparatus 102. In the exemplary arrangement of FIG. 1a, the mounting flange 105 extends in opposed lateral directions. This forms a strip of mounting flange 105 extending either side of the pressure sensor apparatus 102. In the exemplary arrangement of FIG. 1a, the pressure sensor apparatus is retained within the housing 110 and the mounting flange 105 has a width substantially equivalent to the width of the housing 110. However, in other arrangements, the mounting flange 105 may have a width greater than the width of the housing 110. The mounting flange may have a substantially rectangular shape, a substantially circular shape, or any other shape suitable to provide sufficient surface area to adhere the mounting area 108 to the rim.

In the exemplary arrangement shown in FIGS. 1a and 1b, the sensor mount 104 comprises a housing 110. The housing 110 may be configured to at least partially receive, enclose and/or accommodate the pressure sensor apparatus 102.

In the exemplary arrangement of FIGS. 1a and 1b, the sensor mount 104 comprises the housing 110. In such arrangements, the housing 110 and the sensor mount 104 may be integral, i.e. formed from a single component. That is, the mounting flange 105 and the housing 110 may be formed in a continuous piece. The skilled person will appreciate that in alternative arrangements, the housing 110 may be a separate component to the sensor mount 104, and mounted onto a surface of the sensor mount 104. This may be the surface 106 of the sensor mount 104 opposed to the mounting area 108.

The exemplary sensor mount 104 shown in FIG. 1 comprises a recess 112 (visible in FIG. 1b) configured to receive the pressure sensor apparatus 102. The recess is formed in the mounting flange 105. In the exemplary arrangement of FIG. 1, the recess 112 of the sensor mount 104 may be configured to receive a cover 114 (visible in FIG. 1b). The cover 114 may be configured to close or cover the recess 112 and retain the pressure sensor apparatus 102 therein once the pressure sensor apparatus 102 has been inserted. In such arrangements, the pressure sensor apparatus 102 (and further sensor electronics, which are discussed further below) can be pre-assembled and simply inserted into the housing 110. Once the cover 114 is fitted to the aperture 112, the mounting area may be formed by at least part of the mounting flange 105 and at least part of the cover 114.

The exemplary housing 110 may further comprise an aperture 116 configured to expose at least a portion of the pressure sensor apparatus 102. In exemplary arrangements, the aperture 116 exposes the pressure sensor 103 to the fluid retained within the tyre. The tyre pressure sensing module 100 may further comprise a gasket 118. The gasket 118 may be located between a surface of the aperture 116 and the pressure sensor 103. The gasket 118 may be configured to form a fluid-tight seal with an exterior of the housing 110 to prevent ingress of a fluid into the housing 110. The gasket 118 may be ring shaped. This prevent ingress of the fluid into the housing 110 while still exposing a portion of the pressure sensor 103 to the fluid retained within the tyre.

In the exemplary arrangement of FIG. 1, the mounting flange 105 extends laterally from a periphery of the housing 110. The periphery of the housing 110 may be defined by sidewalls 122 of the housing 110.

The mounting area 108 may comprise a surface area for securing the pressure sensor apparatus 102 to the rim that is larger than a cross-sectional area of the periphery of the housing 110. The surface area of the mounting area 108 may be range from: greater than one time to two times, greater than two times to three times, greater than three times to four times and greater than four times to five times larger than the cross-sectional area of the periphery of the housing 110. As such, a larger area is provided for securing the tyre pressure sensing module 100 to the rim than would be provided by the housing 110 and/or pressure sensor apparatus 102 alone. This provides a more secure attachment of the tyre pressure sensing module 100 to the rim.

In the exemplary arrangement of FIG. 1, the mounting flange 105 and therefore the mounting area 108 extends laterally from a pair of opposed sidewalls 122a, 122b of the housing 110. In alternative arrangements, the skilled person will appreciate that the mounting area 108 may extend laterally from any number of sidewalls of the housing 110.

Exemplary tyre pressure sensing module 100 may comprise further electronics. For example, exemplary tyre pressure sensing module 100 may comprise a temperature sensor 124 configured to sense the temperature of the fluid retained within the tyre.

Exemplary tyre pressure sensing modules 100 may further comprise a transmitter and/or receiver. In the exemplary arrangement of FIGS. 1a and 1b, the tyre pressure sensing module 100 comprises an antenna 126. The antenna 126 may be configured to transmit pressure data indicative of the pressure of the fluid sensed by the pressure sensor 103 and/or temperature data indicative of the temperature of the fluid sensed by the temperature sensor 124. In exemplary arrangements, the antenna 126 may comprise a whip antenna. The whip antenna may comprise a flexible rod or wire.

Exemplary tyre pressure sensing modules 100 may further comprise a battery 128 configured to provide power to one or more of the pressure sensor 103, the temperature sensor 124 and other electronic components. The battery 128 may comprise a coin battery.

One or more of the temperature sensor 124, the antenna 126 and the battery 128 may be received within the housing 110 and may form part of the pressure sensor apparatus 102.

As discussed above, the mounting area 108 may be configured to be adhered to the rim. Within this specification, the term “adhere” encompasses any method of binding, joining or otherwise fixing the mounting area 108 to the rim. For example, the mounting area 108 may be adhered to the rim using an adhesive. Alternatively, the mounting area 108 may be adhered to the rim by using heat to melt the mounting area 108 and cause fusion of the mounting area 108 to the rim.

The exemplary tyre pressure sensing module 100 may comprise an adhesive 130 configured to adhere the tyre pressure sensing module 100 to the rim of the wheel.

The adhesive 126 may be located on at least a portion of the mounting area 108. In the exemplary arrangement of FIGS. 1a and 1b, the adhesive is located over substantially the whole of a lower surface 138 of the mounting area 108. The skilled person will appreciate however that in alternative arrangements, the adhesive 130 may be located over only a portion of the mounting area 108. For example, the adhesive may be located over a quarter, a half or three quarters of the mounting area 108 and may be disposed in a predetermined pattern.

The adhesive 130 may comprise a double sided tape. A first side of the double sided tape may be adhered to the mounting area 108 and a second side of the double sided tape may be configured for adherence to the rim. The second side of the double sided tape may be covered by a peelable tab before use and exposed during fitting of the tyre pressure sensing module 100 to the rim by peeling back the tab. Advantageously, use of a double sided tape simplifies the process of fitting the tyre pressure sensing module 100 to the rim. This is because the user is not required to apply an adhesive to the tyre pressure sensing module and/or the rim, or secure the tyre pressure sensing module to the rim using time consuming mechanical fasteners. However, the skilled person will appreciate that in alternative arrangements, alternative methods of adhering the tyre pressure sensing module 100 to the rim may be used. For example, an adhesive may be applied to at least one of the mounting area 108 and rim, and then the pressure sensing module 100 may be pressed against the rim.

To fit the tyre pressure sensing module 100 to the rim of the wheel, the tyre pressure sensing module 100 may be placed onto the rim and the mounting area 108 may be deformed to conform to the radius of the rim. In exemplary arrangements, the mounting flange and therefore at least part of the mounting area 108 may deform under gravitational force to correspond to the radius of the rim. In alternative arrangements, the user may apply a force to the mounting flange 105 in order to deform the mounting area 108 such that it conforms to the radius of the rim.

The user may apply a force to the sensor mount 104 to bind the adhesive to the rim and secure the tyre pressure sensing module 100 to the rim. In the exemplary arrangement of FIGS. 1a and 1b, the user may apply the force to the mounting area 106.

In the exemplary arrangement of FIGS. 1a and 1b, wherein the adhesive comprises a double sided tape, prior to placing the tyre pressure sensing module 100 onto the rim, the user may expose a second side of the double-sided tape. Exposing the second side of the double sided tape may comprise peeling away a tab. In alternative arrangements, the user may place an adhesive onto the mounting area and/or the rim prior to placing the tyre pressure sensing module 100 onto the rim.

FIG. 1c shows an exemplary tyre pressure monitoring system fitted to a rim 140 of a wheel. The rim 140 may comprise a barrel 142 and may further comprise flanges 144a, 144b. In exemplary arrangements, the tyre pressure monitoring system may be fitted to the barrel 142. As shown in FIG. 1c, the mounting area 108 has been deformed such that it conforms to the radius of rim 140. In the exemplary arrangement of FIG. 1c, the mounting area 108 has been deformed to conform to a radius of the barrel 142.

A tyre may then be received by the rim 140 of the wheel such that the tyre pressure sensing module 100 is located in a volume formed between the rim 140 and an inner surface of the tyre.

As will be appreciated by the skilled person, the tyre pressure sensing module 100 is suitable for use with a range of different sized wheels, and is additionally quick and simple to fit to a rim of the wheel. Further, by providing a mounting area of greater surface area than a cross-sectional area of the housing, a more secure fitting is achieved due to the increased area for adhesion to the rim.

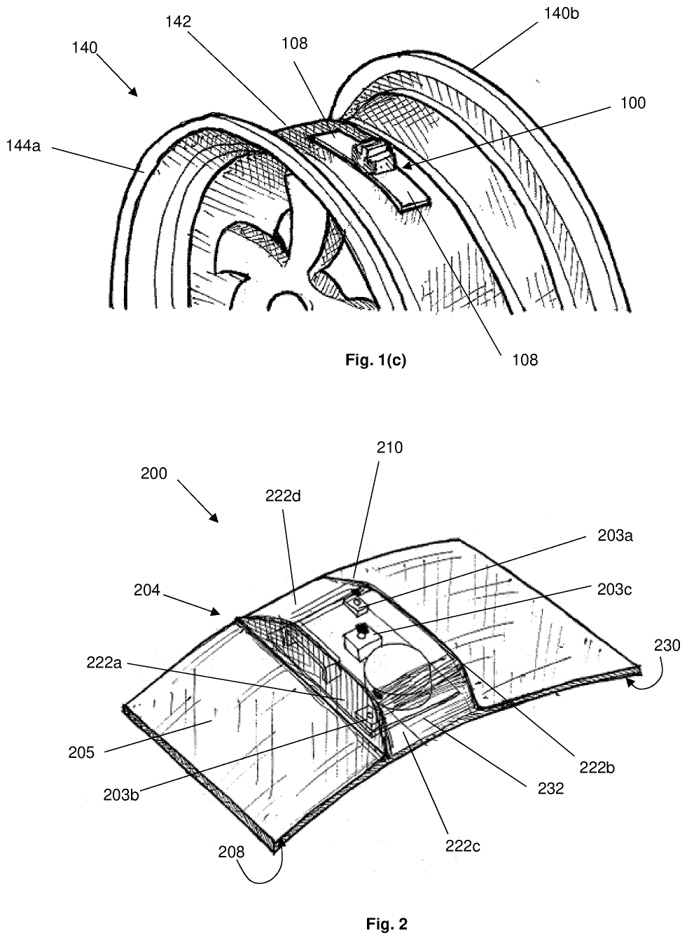

FIG. 2 shows a further exemplary tyre pressure sensing module 200. Many of the features of the tyre pressure sensing module 200 are similar to those described above in respect of FIGS. 1a and 1b. As such, a description of these features is not given again here and corresponding reference numerals are used to identify them in FIG. 2. Therefore, 204 is the sensor mount, 205 is the mounting flange, 208 is the mounting area, 210 is the sensor housing, 222a and 222b are opposed sidewalls of the housing 210, and 230 is the adhesive. One or more of the features described below in relation to FIG. 2 may be used in the exemplary tyre pressure sensing module 100 of FIGS. 1a and 1b.

The exemplary tyre pressure sensing module 200 shown in FIG. 2 may comprise an angled surface 232. In exemplary arrangements, the angled surface 232 may be configured to guide a bead of a tyre over the tyre pressure sensing module 200 on fitting or removal of the tyre to/from the rim.

In the exemplary arrangement 200 of FIG. 2, the angled surface 232 comprises an angled sidewall 222c of the housing 210. The exemplary tyre pressure sensing module 200 of FIG. 2 comprises a pair of opposed angled sidewalls 222c, 222d. This allows at least one of the angled sidewalls 222a, 222b to deflect the bead of the tyre regardless of which direction the tyre is fitted to/removed from the wheel rim. The sidewalls 222c, 222d are angled inwards towards a centre of the housing as they extend away from the mounting area 208. In other arrangements, only an upper portion of the sidewalls 222c, 222d may be angled.

In exemplary arrangements, the height of the tyre pressure sensing module 200 may be 18 mm or less. In further exemplary arrangements, the height of the tyre pressure sensing module 200 may be 10 mm or less.

The tyre pressure sensor module 200 may be particularly advantageous for use on wheels of off the road vehicles. For off the road vehicles the conventional method of fitting the tyre to the rim by stretching the tyre over the rim may not be possible. This may be because the tyre is too large, too heavy or too inflexible, for example. In such applications, the wheel rim may comprise a barrel and a removable rim/flange. The removable rim/flange can be removed from the barrel, and the tyre may then be slid onto the barrel. The removable rim/flange is then reattached to the barrel once the tyre has been received by the barrel. Typically, in such applications magnetically mounted sensors may be used. The magnetically mounted sensors may be fitted to the barrel of the wheel when the tyre has been partially received by the wheel barrel. However magnetically mounted sensors are expensive to produce and typically need to be refitted to the wheel rim every time a tyre is removed and replaced. This is because the magnetic force holding the sensor to the wheel rim is overcome during tyre removal.

The tyre pressure sensor module 200 only needs to be fitted to the wheel rim once. This is because the tyre rides over the angled sidewalls during fitting and removal. Because the tyre rides over the angled sidewalls 222c, 222d, the tyre does not exert a force on the tyre pressure sensing module 200 sufficient to break the bond between the wheel rim and the mounting area 208 formed by the adhesive 230.

The exemplary tyre pressure sensing module 200 (and/or the tyre pressure sensing module 100 of FIGS. 1a and 1b) may further comprise a plurality of pressure sensors 203a-c. The exemplary tyre pressure sensing module 200 comprises three pressure sensors, but the skilled person will appreciate that substantially any number of pressure sensors may be used. Each of the plurality of pressure sensors 203a-c may be configured to sense the pressure of the fluid retained within the tyre.

In exemplary arrangements, the tyre pressure sensing module 200 (and/or the tyre pressure sensing module 100 of FIGS. 1a and 1b) may further comprise a pressure determiner. The pressure determiner may be configured to provide a determined pressure of the fluid contained within the tyre based on the measurements obtained by the plurality of pressure sensors 203a-c. In exemplary arrangements, the pressure determiner may be configured to provide a determined pressure based on an average of the pressure measurements obtained by each of the pressure sensors 203a-c.

In exemplary arrangements, the pressure determiner may be configured to discount a pressure measurement obtained by a pressure sensor 203a if it differs from further pressure measurements obtained by further pressure sensors 203b, 203c by a threshold. In this way false readings, due to contaminants for example, may be rejected.

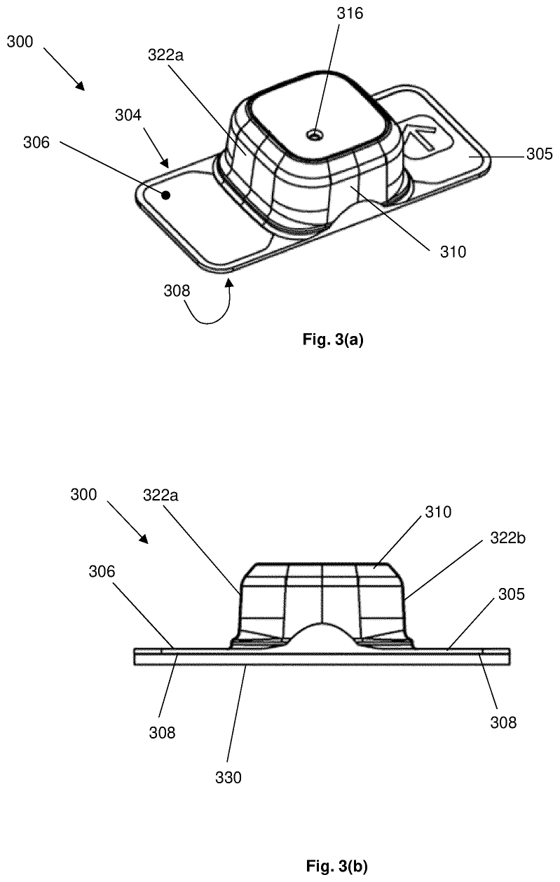

FIGS. 3(a) and 3(b) show an isometric view and a side view respectively of a further exemplary tyre pressure sensing module 300 for fitting to a rim of a wheel of a vehicle. Many of the features of the tyre pressure sensing module 300 are similar to those described above in respect of the tyre pressure sensing module 100 of FIG. 1. As such, a description on these features is not given again here and corresponding reference numerals are used to identify them in FIG. 3. Thus, 304 is the sensor mount, 305 is the mounting flange, 306 is the upper surface of the mounting flange, 308 is the mounting area, 310 is the housing, 316 is the aperture, 322a and 322b are sidewalls of the housing 310, and 330 is an adhesive configured to adhere the tyre pressure sensing module 300 to a rim of a wheel.

Although not visible in FIGS. 3a and 3b, the tyre pressure sensing module 300 may comprise a tyre pressure sensor apparatus similar to the tyre pressure sensor apparatus 102 described in respect of FIG. 1. That is, the tyre pressure sensor apparatus may encompass a plurality of features necessary for operation of a pressure sensor, for example a battery and/or a transmitter and/or a receiver. The tyre pressure sensor apparatus may further comprise a temperature sensor, as described above in respect of the tyre pressure sensing module 100 of FIG. 1. The tyre pressure sensor apparatus may be received within the housing 310 of the tyre pressure sensing module 300 similarly to as described above in respect of the tyre pressure sensing module 100 of FIG. 1.

Similarly to the arrangement described in respect of FIG. 1, the mounting area 308 may comprise a surface area for securing the pressure sensor apparatus to the rim of a wheel that is larger than a cross-sectional area of the periphery of the housing 310. The surface area of the mounting area 108 may be substantially two times the cross-sectional area of the periphery of the housing 310. In an exemplary arrangement, the width of the housing 310 may be approximately 28 mm, and the width of the mounting area 308 may be approximately 55 mm. In alternative arrangements, the surface area of the mounting area 308 may be one of substantially 1.25 time greater; substantially 1.5 times greater, and substantially 1.75 times greater than the cross-sectional area of the periphery of the housing 310.

In the exemplary arrangement shown in FIG. 3, the adhesive 330 may be located over only a portion of the mounting area 108. The tyre pressure sensing module 300 may comprise a plurality of discrete adhesive areas located on the mounting area 308. For example, the tyre pressure sensing module 300 may comprise two adhesive areas located at opposed ends of the mounting area 308. The adhesive areas may be extend along the mounting area 308 either side of the housing 310. As such, the mounting area 308 may comprise an area with no adhesive, and this area may correspond to the area adjacent to the housing 310. The skilled person will appreciate in alternative arrangements, the adhesive 330 may extend over substantially all of the mounting area 308, or the adhesive areas may be alternatively arranged.

The inventors have appreciated that where smaller and lighter tyre pressure sensor apparatus are to be mounted to a wheel rim, a smaller mounting area, and therefore a smaller adhesive area, is needed to provide a strong connection to the wheel rim.

In the exemplary arrangement shown in FIGS. 3a and 3b, the mounting area 308 is substantially planar, or flat. That is, the mounting area 308 is substantially planar in a non-deformed state, before a force is applied to the mounting area 308 to deform the mounting area 308. Tyre pressure sensing modules with substantially planar mounting areas before use may enable easier packing and transportation of the tyre pressure sensing modules 300. The user may then deform the mounting area 308 during installation, as described above in respect of the tyre pressure sensing module 100 of FIG. 1, such that the profile of the mounting area 308 conforms to the radius of the wheel rim to which it is being attached.

The exemplary housing 310 of the tyre pressure sensing module 300 is substantially square. As such, the opposed sidewalls of the housing 310 are substantially parallel to each other. Advantageously, this facilitates grip of the tyre pressure sensing module 300 during assembly/manufacture of the tyre pressure sensing module 300, for example, during pick and place operations. The skilled person will appreciate in alternative arrangements, the housing may be other shapes, for example, substantially rectangular.

The inventors have appreciated that in some applications, rapid and simplified dispensing of the tyre pressure sensing modules for installation may be desired. For example, in a garage in which the tyre pressure sensing modules may be regularly installed on large numbers of vehicles. In such applications, a convenient method of storage of the tyre pressure sensing modules may also be desired.

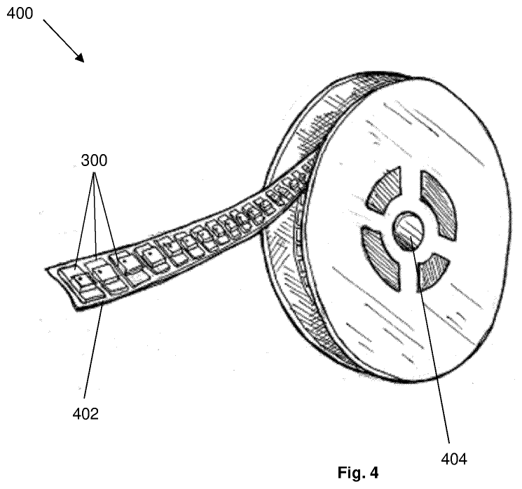

FIG. 4 shows a dispensing apparatus 400 configured to store and dispense a plurality of tyre pressure sensing modules. The dispensing apparatus 400 is described below with reference to the tyre pressure sensing modules 300. However, the skilled person will appreciate that the dispensing apparatus 400 may be configured to store and dispense any of the tyre pressure sensing modules 100, 200, 300.

As described above, in exemplary arrangements, the adhesive 330 of the tyre pressure sensing module 300 may comprise a double sided tape. A first side of the double sided tape may be adhered to the mounting area 308. A second side of the double sided tape may be configured for adherence to the wheel rim during installation of the tyre pressure sensing module 300.

Before use, the second side of the double sided tape of each of the plurality of tyre pressure sensing modules 300 may be adhered to a length of material 402 wound about a reel 404. A plurality of tyre pressure sensing modules 300 may be adhered to the length of material 402, which in turn is wound around the reel 404. The length of material 402 may be peelable such that a tyre pressure sensing module 300 may be peeled away from the length of material 402 to expose the second side of the double sided tape and allow installation of the tyre pressure sensing module 300 on the wheel rim.

The length of material may be pulled by a user to unwind more of the length of material 402 from the reel 404, and therefore expose more tyre pressure sensing modules 300 for removal from the dispensing apparatus 400 and installation on a wheel rim.

As such, a compact storage solution is provided for the tyre pressure sensing modules, and a simplified dispensing and installation process is realised.

The skilled person will be able to envisage further embodiments to those described above, which are intended only as examples, without departing from the scope of the appended claims.

1. A tyre pressure sensing module for fitting to a rim of a wheel of a vehicle, the rim configured to accommodate a tyre, the tyre pressure sensing module comprising:
a pressure sensor apparatus configured to sense a pressure of a fluid retained within the tyre; and
a sensor mount for securing the pressure sensor apparatus to the rim of the wheel, wherein the sensor mount comprises a mounting area configured to be adhered to the rim and that is deformable to accommodate a radius of the rim.

2. A tyre pressure sensing module according to claim 1, wherein the mounting area is deformable to accommodate radii of a plurality of rims.

3. A tyre pressure sensing module according to claim 1, wherein the mounting area is flexibly deformable to accommodate the radius of the rim or the radii of the plurality of rims.

4. A tyre pressure sensing module according to claim 1, wherein the sensor mount comprises a mounting flange, and wherein the mounting area comprises at least part of an underside of the mounting flange.

5. A tyre pressure sensing module according to any claim 4, wherein the mounting flange extends laterally in at least one direction beyond a periphery of the pressure sensor apparatus.

6. A tyre pressure sensing module according to claim 1, further comprising a housing configured to at least partially enclose the pressure sensor apparatus.

7. A tyre pressure sensing module according to claim 6, wherein the sensor mount comprises the housing.

8. A tyre pressure sensing module according to claim 6, wherein the sensor mount comprises a mounting flange, and wherein the mounting area comprises at least part of an underside of the mounting flange, and wherein the housing comprises a recess formed in the mounting flange, and wherein the pressure sensor apparatus is received within the recess.

9. A tyre pressure sensing module according to claim 8 further comprising a cover covering an opening of the recess in the mounting flange and wherein the mounting area comprises at least part of the mounting flange and at least part of the cover.

10. (canceled)

11. A tyre pressure sensing module according to claim 6, wherein the housing comprises an aperture allowing fluid communication from an internal volume of the tyre to the pressure sensor apparatus.

12. A tyre pressure sensing module according to claim 6, wherein the sensor mount comprises a mounting flange, and wherein the mounting area comprises at least part of an underside of the mounting flange, and wherein the mounting flange and the housing are formed in a continuous piece.

13. A tyre pressure sensing module according to claim 1, wherein the sensor mount comprises a deformable sheet.

14. A tyre pressure sensing module according to claim 13, wherein the sensor mount comprises a mounting flange, and wherein the mounting area comprises at least part of an underside of the mounting flange, and wherein at least part of the mounting flange is formed by the deformable sheet.

15. A tyre pressure sensing module according to claim 13, further comprising a housing configured to at least partially enclose the pressure sensor apparatus, and wherein at least part of the housing is formed by the deformable sheet.

16. A tyre pressure sensing module according to claim 1, further comprising an adhesive located on at least a portion of the mounting area, wherein the adhesive comprises a double sided tape, a first side of the double sided tape being adhered to the mounting area, and a second side of the double sided tape configured for adherence to the rim.

17. (canceled)

18. (canceled)

19. (canceled)

20. A tyre pressure sensing module according to claim 1, further comprising a plurality of pressure sensors configured to sense the pressure of a fluid retained within the tyre and/or a temperature sensor configured to sense the temperature of the fluid retained within the tyre.

21. A tyre pressure sensing module according to claim 1, further comprising a transmitter configured to transmit data indicative of the sensed pressure of the fluid.

22. (canceled)

23. (canceled)

24. A wheel of a vehicle comprising:
a rim configured to accommodate a tyre; and
a tyre pressure sensing module according to claim 1 adhered to the rim.

25. A vehicle comprising a wheel according to claim 24.

26. A dispensing apparatus configured to store and dispense a plurality of tyre pressure sensing modules, the dispensing apparatus comprising:
a plurality of tyre pressure sensing modules according to claim 16;
a reel; and
a length of dispensing material wound about the reel, wherein the second side of the double sided tape of each of the plurality of tyre pressure sensing modules is adhered to the length of dispensing material, and wherein removal of any one of the plurality of tyre pressure sensing modules from the length of dispensing material exposes the second side of the double sided tape for installation of the tyre pressure sensing module on the wheel rim.
